(19) United States
(12) Patent Application Publication
(10) Pub. No.: US 2019/0383400 A1
(43) Pub. Date: Dec. 19, 2019

(54) Quantitative water adjusting valve

(71) Applicant: Jiangsu Suyan Valve Machinery Co.,Ltd, Jiangsu Province 224500 (CN)

(72) Inventors: Zhenghai Han, Jiangsu Province 224500 (CN); Wenhao Han, Jiangsu Province 224500 (CN); Wenwen Han, Jiangsu Province 224500 (CN); Yu Han, Jiangsu Province 224500 (CN); Sheng Han, Jiangsu Province 224500 (CN)

(21) Appl. No.: 16/034,161

(22) Filed: Jul. 12, 2018

(30) Foreign Application Priority Data
Jun. 19, 2018 (CN) 201810630454.5

(51) Int. Cl. F16K 1/12; F16K 1/38; F16K 27/02

(52) U.S. Cl. CPC F16K 1/12; F16K 21/00; F16K 27/0254; F16K 1/38

(57) ABSTRACT

The invention relates to a valve, in particular to a quantitative water adjusting valve which comprises a valve body and a sealing pressure column, a control mechanism, a sealing element, a quantitative orifice plate and an end cover. The device disclosed by the invention is convenient to detach, so that the internal structure of the device is convenient to maintain; the valve can be quickly opened, and the valve can be slowly opened and closed through threads; under the condition that the water pressure is certain, the flow of water can be conveniently and quantitatively controlled.

### CROSS REFERENCE TO RELATED APPLICATION

This application claims priority from Chinese Patent Application No. 201810630454.5, filed Jun. 19, 2018 and entitled “QUANTITATIVE WATER ADJUSTING VALVE” the disclosure of which is hereby incorporated entirely herein by reference.

### FIELD OF THE INVENTION

The invention relates to a valve, in particular to a quantitative water regulating valve.

### BACKGROUND OF THE INVENTION

The invention discloses a valve with the application number of CN201320121685.6. The utility model relates to a valve, in particular to a hydraulic control valve which is controlled by a computer and controls the valve to work through a fluid pressure difference through an electromagnetic pilot valve. According to the technical scheme, a high-voltage interface and a low-voltage interface are respectively communicated with an inlet and an outlet of a valve. The interior of the valve is divided into three cavities; the valve core is connected with a piston and a cavity through a hollow connecting rod to form a hydraulic cylinder structure. The cavity is respectively communicated with the high-voltage interface and the low-voltage interface through the electromagnetic valve, electromagnetic valve to determine the conduction state of the cavity and the high-low-pressure interface, so that the action of opening or closing the valve is completed. A shifting rod and a piston are used as a transmission mechanism, and a magnet is arranged on the shifting rod shaft, and a linear hall sensor; the computer is used for measuring the position of the valve according to the position sensor signals, the working states of the valves are controlled through the electromagnetic valves according to external control signals, and different use requirements are met. However, the utility model is not easy to detach and is not convenient to repair.

### SUMMARY OF THE INVENTION

The invention provides a quantitative water adjusting valve, the device and the method have the beneficial effects that the structure is convenient to detach, so that the internal structure of the device is convenient to maintain; the valve can be quickly opened, and the valve can be slowly opened and closed through threads; under the condition that the water pressure is certain, the flow of water can be conveniently and quantitatively controlled.

The invention relates to a valve, in particular to a quantitative water adjusting valve which comprises a valve body and a sealing pressure column, a control mechanism, a sealing element, a quantitative orifice plate and an end cover. The device disclosed by the invention is convenient to detach, so that the internal structure of the device is convenient to maintain; the valve can be quickly opened, and the valve can be slowly opened and closed through threads; under the condition that the water pressure is certain, the flow of water can be conveniently and quantitatively controlled.

The sealing pressure column is slidably connected to the upper end of valve body; the control mechanism is fixedly connected to the upper end of the valve body; the control mechanism and is inserted into the upper end of the sealing pressure column in two modes; the sealing element is fixedly connected to the upper end of the valve body ; the sealing element is positioned in the valve body; the sealing pressure column is in sliding connection with the sealing element, and the quantitative orifice plate is fixedly connected to the valve body; the two end covers are respectively and fixedly connected to the front end and the rear end of the valve body.

The valve body comprises a valve frame, an interface tube I, a fixed column, a smooth groove, a circular baffle plate, a spring and a spring sleeve rod, an upper water tank, an interface tube II and a middle partition plate, a lower water tank, sealing gasket and an corner plate, a water passing orifice, a quantitative orifice plate inserting groove, a threaded column, a lug plate groove and a circular shaped sealing gasket; the valve frame is of a rectangular frame structure; the middle end of the interior of the valve frame is fixedly connected with a middle partition plate, and a water passing orifice is formed in the center of the middle partition plate, and a quantitative orifice plate inserting groove is formed in the upper end of the water passing orifice; the bottom surface of the quantitative orifice plate inserting groove is adhered with a circular shaped sealing gasket; lug plate grooves are formed in the left end and the right end of the quantitative orifice plate inserting groove; threaded columns are fixedly connected to the bottom surfaces of the two lug plate grooves; and a middle partition plate divide the valve frame into an upper water tank at the upper end and a lower water tank at the lower end; an interface tube I is fixedly connected to the upper end of the left side of a valve frame, the interface tube I is communicated with the upper water tank, an interface tube II is fixedly connected to the lower end of the right side of a valve frame, the interface tube II is communicated with the lower water tank, a smooth groove is formed in the center of the upper end of a valve frame),fixed column is fixedly connected to the left side of the upper end of a valve frame, nut I is connected to fixed column through threads, spring sleeve rod is fixedly connected to the right side of the upper end of valve frame, spring is connected to the upper of spring sleeve rod, circular baffle is fixedly connected to the upper of spring sleeve rod, corner plates are fixedly connected to the four corners of the front end face of the valve frame and four corners of the rear end face of the valve frame. sealing gasket are adhered to the front end face and the rear end face of the valve frame.

The sealing pressure column comprises a column pressing body, an annular groove and an upper ring, a matching convex block, a conical rubber plug and a connecting plate and a bottom insertion column; and a bottom insertion column is fixedly connected to the lower end of the column pressing body, the center of the conical rubber plug is inserted on the bottom insertion column, the lower end of the bottom insertion column is connected with a nut II through threads, the nut II abuts against the bottom surface of the conical rubber plug, the upper end of the column pressing body is fixedly connected with a connecting plate, the upper end of the connecting plate is fixedly connected with an upper ring, annular groove is formed between upper ring and column pressing body, the right end of the column pressing body is fixedly connected with a matching convex block, the matching convex block is slidably connected to the spring sleeve rod, the spring is positioned between the circular baffle plate and the matching convex block, the column pressing body is slidably connected to the smooth groove, the conical rubber plug is positioned in valve frame.

The control mechanism comprises a vertical rotating plate and a rotating convex plate, an extending plate, a hand-rotating disk and a long screw rod, a positioning insert block a limit stop and an elastic band; the left end of the lower end of the vertical rotating plate is fixedly connected with a rotating convex plate; the rotating convex plate is in clearance fit with the fixed column; the nut I on fixed column is positioned at the upper end of the rotating convex plate; the vertical rotating plate is slidably connected with a positioning insert block; the left end of the positioning insert block is fixedly connected with a limit stop; the limit stop is positioned at the left end of the vertical rotating plate, the two ends of the elastic band are fixedly connected to the front end face and the rear end face of the vertical rotating plate respectively, elastic band is pressed at the left end of positioning insert block, the right end of the positioning insert block is inserted into the annular groove; right lower end of positioning insert block is an inclined surface; the front end of the lower end of the vertical rotating plate is fixedly connected with an extending plate; the upper end of the extending plate is fixedly connected with a long screw rod; the long screw rod is connected with the hand-rotating disk through threads.

The sealing element comprises a stepped rubber ring and a ring; the stepped rubber ring is of an upper wide lower narrow step shape, and the lower end of the stepped rubber ring is sleeved with a ring, and the ring is fixedly connected to the valve frame through a screw, the stepped rubber ring is in sliding fit with the column pressing body.

The quantitative orifice plate comprises an orifice plate body and a lug plate; the orifice plate body is in clearance fit with the quantitative orifice plate inserting groove, lug plates are arranged at the left end and the right end of the orifice plates, the two orifice plates and the lug plate are respectively inserted into the two lug plate grooves; the two threaded columns is inserted into the lug plate in a clearance fit manner; the two threaded columns is connected with a nut III through threads; the orifice plate body is pressed on the circular shaped sealing gasket; the two nuts III are pressed on the upper ends of the orifice plate bodies.

The two end covers is fixedly connected to the front end and the rear end of the valve frame respectively; the end cover is connected to four corner plates through screws.

The orifice plate body is provided with a plurality of orifices; a plurality of orifices in the plurality of orifice plate bodies are provided with a plurality of sizes.

The quantitative water adjusting valve comprises the following beneficial effects:

The quantitative water adjusting valve. The device disclosed by the invention is convenient to detach, so that the internal structure of the device is convenient to maintain; the valve can be quickly opened, and the valve can be slowly opened and closed through threads; under the condition that the water pressure is certain, the flow of water can be conveniently and quantitatively controlled.

### BRIEF DESCRIPTION OF THE FIGURES

The present invention will be described in further detail with reference to the accompanying drawings and the specific implementation method.

FIG. 1 is a structural schematic diagram of a quantitative water adjusting valve according to the present invention;

FIG. 2 is a structural schematic diagram of a quantitative water adjusting valve according to the present invention;

FIG. 3 is a structural schematic diagram of a valve body;

FIG. 4 is a structural schematic diagram of a valve body;

FIG. 5 is a structural schematic diagram of partition plate;

FIG. 6 is a structural schematic diagram of a sealing pressure column;

FIG. 7 is a structural schematic diagram of a sealing pressure column;

FIG. 8 is a structural schematic diagram of a control mechanism;

FIG. 9 is a structural schematic diagram of a control mechanism;

FIG. 10 is a structural schematic diagram of a sealing element;

FIG. 11 is a structural schematic diagram of a quantitative orifice plate;

FIG. 12 is a structural schematic diagram of an end cover.

In Figures: valve body 1; Valve frame 1-1; Interface tube I1-2; Fixed column 1-3; Smooth groove 1-4; Circular baffle 1-5; Spring 1-6; Spring sleeve rod 1-7; Upper water tank 1-8; Interface tube II1-9; Middle partition plate 1-10; Lower water tank 1-11; [symbol] -typed sealing gasket 1-12; Corner plate 1-13; Water passing hole 1-14; Quantitative orifice plate inserting groove 1-15; Threaded column 1-16; Lug plate groove 1-17; Circular shaped sealing gasket 1-18; Sealing pressure column 2; Column pressing body 2-1; Annular groove 2-2; Upper ring 2-3; Matching convex block 2-4; Conical rubber plug 2-5; Connecting plate 2-6; Bottom insertion column 2-7; Control mechanism 3; Vertical rotating plate 3-1; Rotating convex plate 3-2; Extending plate 3-3; Hand-rotating disk 3-4; Long screw rod 3-5; Positioning insert block 3-6; Limit stop3-7; Elastic band 3-8; Sealing element 4; Stepped rubber ring 4-1; Ring 4-2; Quantitative orifice plate 5; Orifice plate body 5-1; Lug plate 5-2; End cover 6.

### DETAILED DESCRIPTION OF THE INVENTION

Specific Implementation Mode 1:

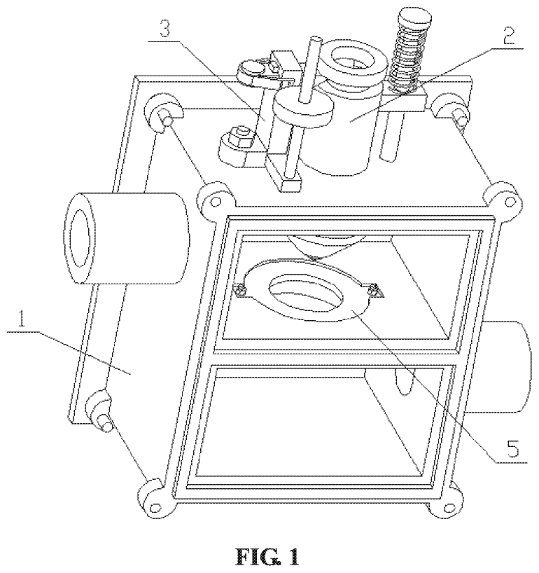

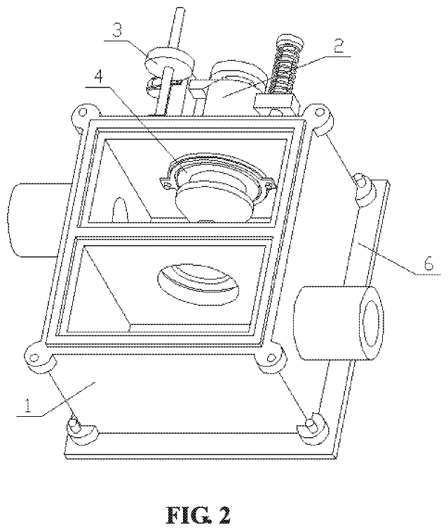

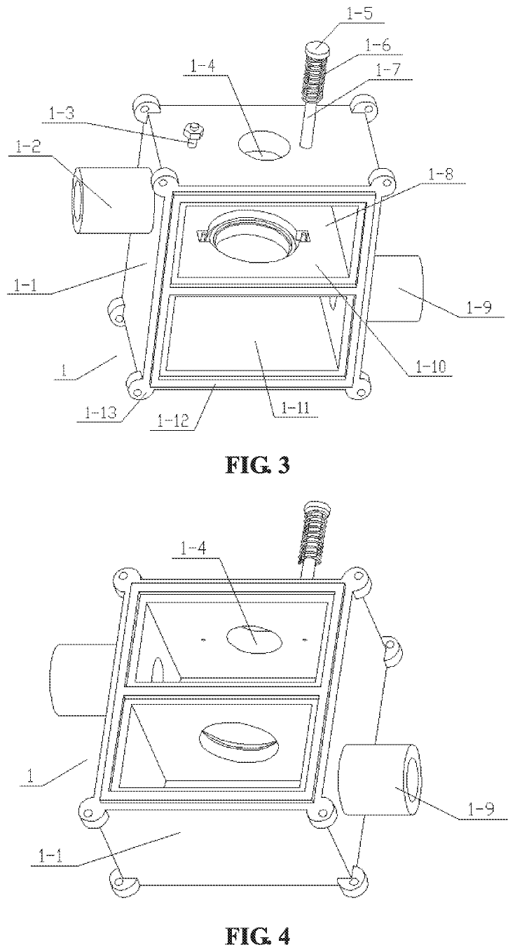

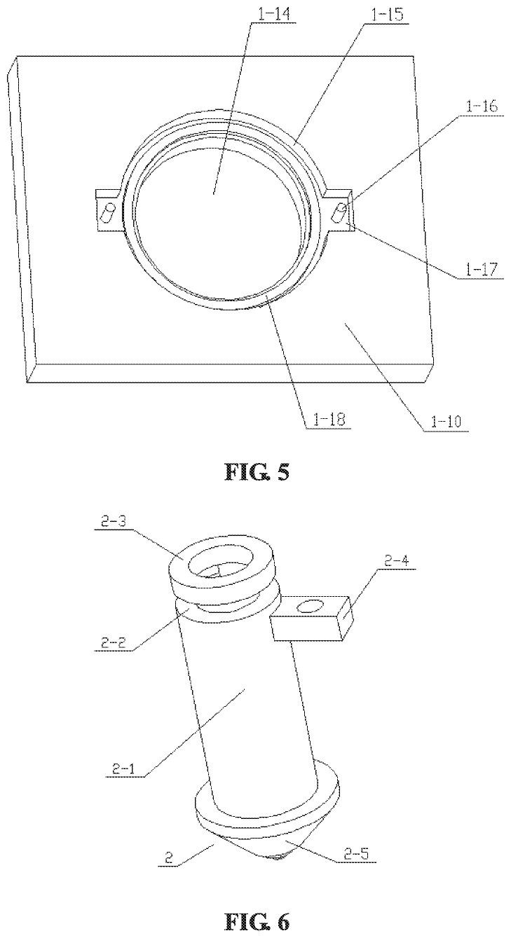

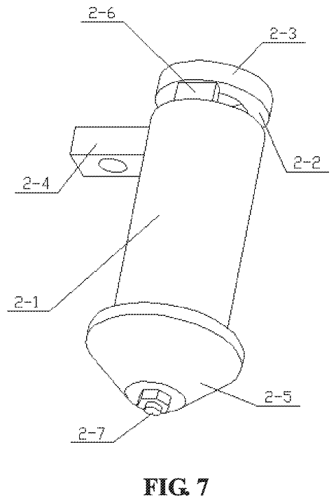

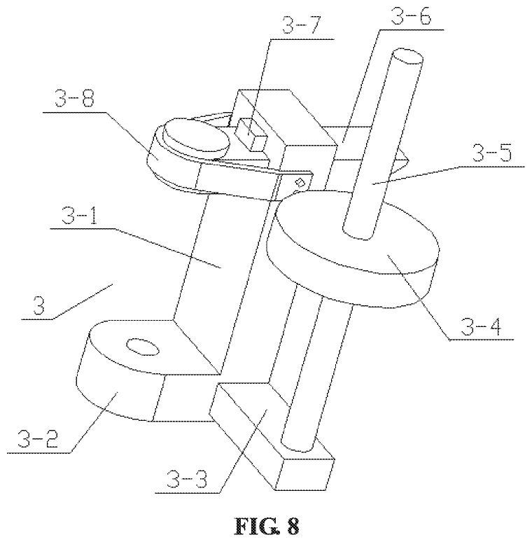

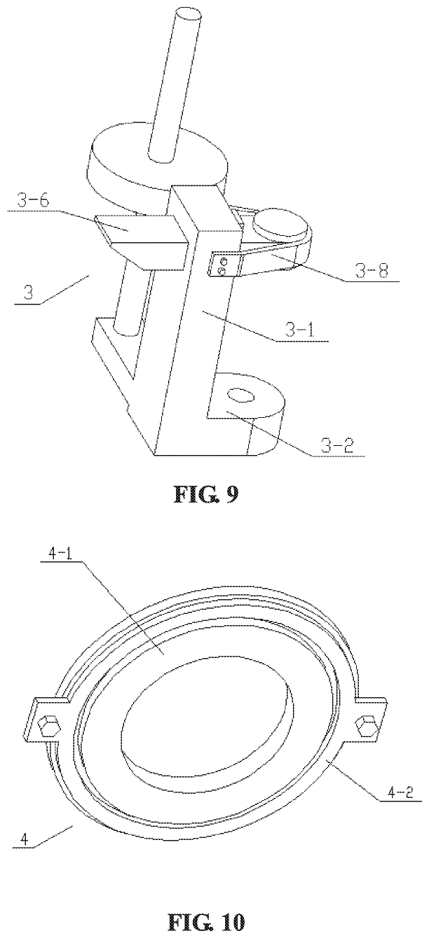

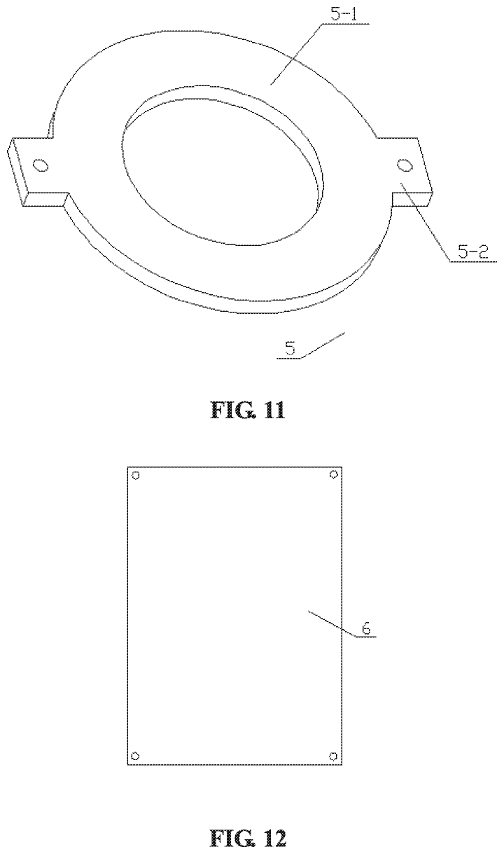

The embodiment is described below with reference to FIGS. 1-12. The invention relates to a valve, in particular to a quantitative water adjusting valve which comprises a valve body 1 and a sealing pressure column 2, a control mechanism 3, a sealing element 4, a quantitative orifice plate 5 and an end cover 6. The device disclosed by the invention is convenient to detach, so that the internal structure of the device is convenient to maintain; the valve can be quickly opened, and the valve can be slowly opened and closed through threads; under the condition that the water pressure is certain, the flow of water can be conveniently and quantitatively controlled.

The sealing pressure column 2 is slidably connected to the upper end of valve body 1; the control mechanism 3 is fixedly connected to the upper end of the valve bodyl; the control mechanism 3 and is inserted into the upper end of the sealing pressure column 2 in two modes; the sealing element 4 is fixedly connected to the upper end of the valve body 1; the sealing element 4 is positioned in the valve body1; the sealing pressure column 2 is in sliding connection with the sealing element 4, and the quantitative orifice plate 5 is fixedly connected to the valve body 1; the two end covers 6 are respectively and fixedly connected to the front end and the rear end of the valve body 1.

The valve body comprises a valve frame 1-1, an interface tube I 1-2, a fixed column 1-3, a smooth groove 1-4, a circular baffle plate 1-5, a spring 1-6 and a spring sleeve rod 1-7, an upper water tank 1-8, an interface tube II 1-9 and a middle partition plate 1-10, a lower water tank 1-11, [symbol] -typed sealing gasket 1-12 and an corner plate 1-13, a water passing orifice 1-14, a quantitative orifice plate inserting groove 1-15, a threaded column 1-16, a lug plate groove 1-17 and a circular shaped sealing gasket 1-18; the valve frame 1-1 is of a rectangular frame structure; the middle end of the interior of the valve frame 1-1 is fixedly connected with a middle partition plate 1-10, and a water passing orifice is formed in the center of the middle partition plate 1-10, and a quantitative orifice plate inserting groove 1-15 is formed in the upper end of the water passing orifice 1-14; the bottom surface of the quantitative orifice plate inserting groove 1-15 is adhered with a circular shaped sealing gasket 1-18; lug plate grooves 1-17 are formed in the left end and the right end of the quantitative orifice plate inserting groove 1-15; threaded columns 1-16 are fixedly connected to the bottom surfaces of the two lug plate grooves 1-17; and a middle partition plate 1-10 divide the valve frame 1-1 into an upper water tank 1-8 at the upper end and a lower water tank 1-11 at the lower end; an interface tube I 1-2 is fixedly connected to the upper end of the left side of a valve frame 1-1, the interface tube I 1-2 is communicated with the upper water tank 1-8, the interface tube II 1-9 is fixedly connected to the lower end of the right side of the valve frame 1-1, the interface tube II 1-9 is communicated with the lower water tank 1-11, the smooth groove 1-4 is formed in the center of the upper end of the valve frame 1-1, fixed column 1-3 is fixedly connected to the left side of the upper end of a valve frame 1-1, nut I is connected to fixed column 1-3 through threads, spring sleeve rod 1-7 is fixedly connected to the right side of the upper end of valve frame 1-1, spring 1-6 is connected to the upper of spring sleeve rod 1-7, circular baffle 1-5 is fixedly connected to the upper of spring sleeve rod 1-7, corner plates 1-13 are fixedly connected to the four corners of the front end face of the valve frame 1-1 and four corners of the rear end face of the valve frame 1-1, [symbol] -typed sealing gasket 1-12 are adhered to the front end face and the rear end face of the valve frame 1-1. The interface tube I 1-2 and the interface tube II 1-9 for connecting water tube, water can enter the upper water tank 1-8 from the interface tube I1-2. When the water passing orifice 1-14 are sealed, and water in the upper water tank 1-8 cannot enter the lower water tank 1-11 from the water passing orifice 1-14, when the water passing orifice 1-14 are opened, and water in the upper water tank 1-8 enters the lower water tank 1-11 from the water passing orifice 1-14, and water in the lower water tank 1-11 flows out through the interface tube II 1-9, an adsorption material can be placed in the lower water tank 1-11, so that water can be purified.

The sealing pressure column 2 comprises a column pressing body 2-1, an annular groove 2-2 and an upper ring 2-3, a matching convex block 2-4, a conical rubber plug 2-5 and a connecting plate 2-6 and a bottom insertion column 2-7; and a bottom insertion column 2-7 is fixedly connected to the lower end of the column pressing body 2-1, the center of the conical rubber plug 2-5 is inserted on the bottom insertion column 2-7, the lower end of the bottom insertion column 2-7 is connected with a nut II through threads, the nut II abuts against the bottom surface of the conical rubber plug 2-5, the upper end of the column pressing body 2-1 is fixedly connected with a connecting plate 2-6, the upper end of the connecting plate 2-6 is fixedly connected with an upper ring 2-3, annular groove 2-2 is formed between upper ring 2-3 and column pressing body 2-1, the right end of the column pressing body 2-1 is fixedly connected with a matching convex block 2-4, the matching convex block 2-4 is slidably connected to the spring sleeve rod 1-7, the spring 1-6 is positioned between the circular baffle plate 1-5 and the matching convex block 2-4, the column pressing body 2-1 is slidably connected to the smooth groove 1-4, the conical rubber plug 2-5 is positioned in valve frame 1-1. The column pressing body 2-1 can slide vertically on the smooth groove 1-4, and the matching convex block 2-4 can slide on the spring sleeve rod 1-7, the nut II at the lower end of the bottom insertion column 2-7 is detached, and the conical rubber plug 2-5 can be detached and replaced.

The control mechanism 3 comprises a vertical rotating plate 3-1 and a rotating convex plate 3-, an extending plate 3-3, a hand-rotating disk 3- and a long screw rod 3-5, a positioning insert block 3-6, a limit stop 3-7 and an elastic band 3-8; the left end of the lower end of the vertical rotating plate 3-1 is fixedly connected with a rotating convex plate 3-2; the rotating convex plate 3-2 is in clearance fit with the fixed column 1-3; the nut I on fixed column 1-3 is positioned at the upper end of the rotating convex plate 3-2; the vertical rotating plate 3-1 is slidably connected with a positioning insert block 3-6; the left end of the positioning insert block 3-6 is fixedly connected with a limit stop 3-7; the limit stop 3-7 is positioned at the left end of the vertical rotating plate 3-1, the two ends of the elastic band 3-8 are fixedly connected to the front end face and the rear end face of the vertical rotating plate 3-1 respectively, elastic band 3-8 is pressed at the left end of positioning insert block 3-6, the right end of the positioning insert block 3-6 is inserted into the annular groove 2-2; right lower end of positioning insert block 3-6 is an inclined surface; the front end of the lower end of the vertical rotating plate 3-1 is fixedly connected with an extending plate 3-3; the upper end of the extending plate 3-3 is fixedly connected with a long screw rod 3-5; the long screw rod 3-5 is connected with the hand-rotating disk 3-4 through threads. The rotating convex plate 3-2 can rotate on the fixing columns 1-3, and the nut I at the upper end of the fixed column 1-3 can be rotated to fix the rotating convex plate 3-2, and the elastic band 3-8 are used for giving the force for positioning insert block 3-6 to move rightwards, the limit stop 3-7 plays a role in limiting the movement of the positioning insert block 3-6 to the right. When the column pressing body 2-1 is moved upwards, when the limit stop 3-7 is inserted into the annular groove 2-2, and the position of the column pressing body 2-1 is fixed, and the positioning insert block 3-6 is pulled out from the annular groove 2-2, due to the fact that the springs 1-6 give force matched with the matching convex block 2-4 downwards, the column pressing body 2-1 moves downwards, and the valve can be quickly opened and closed. When the rotating convex plate 3-2 rotates anticlockwise, the hand-rotating disk 3-4 is inserted into the annular groove 2-2, the positioning insert block 3-6 is not matched with the annular groove 2-2 any more, and at the moment, the hand-rotating disk 3-4 can be rotated to slowly control the lifting of the column pressing body 2-1, the valve can be controlled to be opened and closed slowly through threads, and when the water pressure is too large, when the lower pressure of the column pressing body 2-1 is given by the spring 1-6, the valve can be reliably closed when the hand-rotating disk 3-4 is rotated downwards.

The sealing element 4 comprises a stepped rubber ring 4-1 and a ring 4-2; the stepped rubber ring 4-1 is of an upper wide lower narrow step shape, and the lower end of the stepped rubber ring 4-1 is sleeved with a ring 4-2, and the ring 4-2 is fixedly connected to the valve frame 1-1 through a screw 1-1, the stepped rubber ring 4-1 is in sliding fit with the column pressing body 2-1. The stepped rubber ring 4-1 can seal the sliding fit positions of the column pressing body 2-1 and the smooth groove 1-4, so that water leakage is prevented.

The quantitative orifice plate 5 comprises an orifice plate body 5-1 and a lug plate 5-2; the orifice plate body 5-1 is in clearance fit with the quantitative orifice plate inserting groove 1-15, lug plates 5-2 are arranged at the left end and the right end of the orifice plates 5-1 , the two orifice plates 5-1 and the lug plate 5-2 are respectively inserted into the two lug plate grooves 1-17; the two threaded columns 1-16 is inserted into the lug plate 5-2 in a clearance fit manner; the two threaded columns 1-16 is connected with a nut III through threads; the orifice plate body 5-1 is pressed on the circular shaped sealing gasket 1-18; the two nuts III are pressed on the upper ends of the orifice plate bodies 5-1. Different orifice plate bodies 5-1 can be inserted into the quantitative orifice plate inserting groove 1-15, a plurality of orifices in the plurality of orifices plate bodies 5-1 are provided with a plurality of sizes, so that the flow of the water passing through the orifices plate bodies 5-1 is different, so that the flow of the valve under the condition of certain water pressure is controlled. When the conical rubber plug 2-5 moves downwards, orifices in the orifice plates 5-1 can be plugged, due to the fact that the conical rubber plug 2-5 are conical, so that the conical rubber plug 2-5 can block orifices of different sizes., when the nuts III on the two threaded columns 1-16 are detached, and the orifice plates 5-1 can be detached and replaced. The circular shaped sealing gasket 1-18 plays a role in sealing between the quantitative orifice plate 5 and the middle partition plate 1-10.

The two end covers 6 is fixedly connected to the front end and the rear end of the valve frame 1-1 respectively; the end cover 6 is connected to four corner plates 1-13 through screws. The two end covers 6 can be detached, so that the interior of the valve body 1 can be repaired conveniently, and adsorption materials can be conveniently placed into the lower water tank 1-11, the [symbol] -typed sealing gasket 1-12 plays a role in sealing.

The orifice plate body 5-1 is provided with a plurality of orifices; a plurality of orifices in the plurality of orifice plate bodies 5-1 are provided with a plurality of sizes.

The working principle of the invention is as follows: the interface tube I 1-2 and the interface tube II 1-9 for connecting water tube, water can enter the upper water tank 1-8 from the interface tube I1-2. When the water passing orifice 1-14 are sealed, and water in the upper water tank 1-8 cannot enter the lower water tank 1-11 from the water passing orifice 1-14, when the water passing orifice 1-14 are opened, and water in the upper water tank 1-8 enters the lower water tank 1-11 from the water passing orifice 1-14, and water in the lower water tank 1-11 flows out through the interface tube II 1-9, an adsorption material can be placed in the lower water tank 1-11, so that water can be purified. The column pressing body 2-1 can slide vertically on the smooth groove 1-4, and the matching convex block 2-4 can slide on the spring sleeve rod 1-7, the nut II at the lower end of the bottom insertion column 2-7 is detached, and the conical rubber plug 2-5 can be detached and replaced. The rotating convex plate 3-2 can rotate on the fixing columns 1-3, and the nut I at the upper end of the fixed column 1-3 can be rotated to fix the rotating convex plate 3-2, and the elastic band 3-8 are used for giving the force for positioning insert block 3-6 to move rightwards, the limit stop 3-7 plays a role in limiting the movement of the positioning insert block 3 -6 to the right. When the column pressing body 2-1 is moved upwards, when the limit stop 3-7 is inserted into the annular groove 2-2, and the position of the column pressing body 2-1 is fixed, and the positioning insert block 3-6 is pulled out from the annular groove 2-2, due to the fact that the springs 1-6 give force matched with the matching convex block 2-4 downwards, the column pressing body 2-1 moves downwards, and the valve can be quickly opened and closed. When the rotating convex plate 3-2 rotates anticlockwise, the hand-rotating disk 3-4 is inserted into the annular groove 2-2, the positioning insert block 3-6 is not matched with the annular groove 2-2 any more, and at the moment, the hand-rotating disk 3-4 can be rotated to slowly control the lifting of the column pressing body 2-1, the valve can be controlled to be opened and closed slowly through threads, and when the water pressure is too large, when the lower pressure of the column pressing body 2-1 is given by the spring 1-6, the valve can be reliably closed when the hand-rotating disk 3-4 is rotated downwards. The stepped rubber ring 4-1 can seal the sliding fit positions of the column pressing body 2-1 and the smooth groove 1-4, so that water leakage is prevented. Different orifice plate bodies 5-1 can be inserted into the quantitative orifice plate inserting groove 1-15, a plurality of orifices in the plurality of orifices plate bodies 5-1 are provided with a plurality of sizes, so that the flow of the water passing through the orifices plate bodies 5-1 is different, so that the flow of the valve under the condition of certain water pressure is controlled. When the conical rubber plug 2-5 moves downwards, orifices in the orifice plates 5-1 can be plugged, due to the fact that the conical rubber plug 2-5 are conical, so that the conical rubber plug 2-5 can block orifices of different sizes., when the nuts III on the two threaded columns 1-16 are detached, and the orifice plates 5-1 can be detached and replaced. The circular shaped sealing gasket 1-18 plays a role in sealing between the quantitative orifice plate 5 and the middle partition plate 1-10. The two end covers 6 can be detached, so that the interior of the valve body 1 can be repaired conveniently, and adsorption materials can be conveniently placed into the lower water tank 1-11, the [symbol] -typed sealing gasket 1-12 plays a role in sealing.

Definitely, the above description is not a limitation of the present invention and is not limited to the above examples. Variations, modifications, additions, or substitutions made within the essential scope of the invention by general technicians in the field of operation are also belong to the protection scope of the invention.

1. The quantitative water adjusting valve comprises a valve body(1) and a sealing pressure column(2), a control mechanism(3), a sealing element(4), a quantitative orifice plate(5) and an end cover (6) and is characterized in that the sealing pressure column(2) is slidably connected to the upper end of valve body (1); the control mechanism(3) is fixedly connected to the upper end of the valve body(1); the control mechanism (3) and is inserted into the upper end of the sealing pressure column(2) in two modes; the sealing element (4) is fixedly connected to the upper end of the valve body(1); the sealing element(4) is positioned in the valve body(1); the sealing pressure column (2) is in sliding connection with the sealing element(4), and the quantitative orifice plate(5) is fixedly connected to the valve body (1); the two end covers(6) are respectively and fixedly connected to the front end and the rear end of the valve body(1).

2. The quantitative water adjusting valve according to claim 1, and is characterized in that the valve body comprises a valve frame (1-1), an interface tube I (1-2), a fixed column (1-3), a smooth groove (1-4), a circular baffle plate (1-5), a spring (1-6) and a spring sleeve rod (1-7), an upper water tank (1-8), an interface tube II (1-9) and a middle partition plate (1-10), a lower water tank (1-11), [symbol] -typed sealing gasket (1-12) and an corner plate (1-13), a water passing orifice (1-14), a quantitative orifice plate inserting groove (1-15), a threaded column (1-16), a lug plate groove (1-17) and a circular shaped sealing gasket (1-18); the valve frame (1-1) is of a rectangular frame structure; the middle end of the interior of the valve frame (1-1) is fixedly connected with a middle partition plate (1-10), and a water passing orifice is formed in the center of the middle partition plate (1-10), and a quantitative orifice plate inserting groove(1-15) is formed in the upper end of the water passing orifice (1-14) ; the bottom surface of the quantitative orifice plate inserting groove (1-15) is adhered with a circular shaped sealing gasket (1-18); lug plate grooves(1-17) are formed in the left end and the right end of the quantitative orifice plate inserting groove(1-15); threaded columns(1-16) are fixedly connected to the bottom surfaces of the two lug plate grooves(1-17) ; and a middle partition plate (1-10) divide the valve frame (1-1) into an upper water tank (1-8) at the upper end and a lower water tank(1-11) at the lower end; an interface tube I (1-2) is fixedly connected to the upper end of the left side of a valve frame (1-1), the interface tube I (1-2) is communicated with the upper water tank (1-8), an interface tube II (1-9) is fixedly connected to the lower end of the right side of a valve frame (1-1), the interface tube II (1-9) is communicated with the lower water tank (1-11), a smooth groove(1-4) is formed in the center of the upper end of a valve frame (1-1),fixed column (1-3) is fixedly connected to the left side of the upper end of a valve frame(1-1), nut I is connected to fixed column(1-3) through threads, spring sleeve rod(1-7) is fixedly connected to the right side of the upper end of valve frame(1-1), spring(1-6) is connected to the upper of spring sleeve rod(1-7), circular baffle(1-5) is fixedly connected to the upper of spring sleeve rod(1-7), corner plates(1-13) are fixedly connected to the four corners of the front end face of the valve frame(1-1) and four corners of the rear end face of the valve frame(1-1). [symbol] -typed sealing gasket (1-12) are adhered to the front end face and the rear end face of the valve frame (1-1).

3. The quantitative water adjusting valve according to claim 2 is characterized in that the sealing pressure column (2) comprises a column pressing body (2-1), an annular groove (2-2) and an upper ring (2-3), a matching convex block (2-4), a conical rubber plug (2-5) and a connecting plate (2-6) and a bottom insertion column (2-7); and a bottom insertion column (2-7) is fixedly connected to the lower end of the column pressing body (2-1), the center of the conical rubber plug (2-5) is inserted on the bottom insertion column (2-7), the lower end of the bottom insertion column (2-7) is connected with a nut II through threads, the nut II abuts against the bottom surface of the conical rubber plug (2-5), the upper end of the column pressing body (2-1) is fixedly connected with a connecting plate(2-6), the upper end of the connecting plate(2-6) is fixedly connected with an upper ring (2-3), annular groove(2-2) is formed between upper ring(2-3) and column pressing body (2-1), the right end of the column pressing body (2-1) is fixedly connected with a matching convex block (2-4), the matching convex block(2-4) is slidably connected to the spring sleeve rod(1-7), the spring(1-6) is positioned between the circular baffle plate (1-5) and the matching convex block(2-4), the column pressing body (2-1) is slidably connected to the smooth groove (1-4), the conical rubber plug (2-5) is positioned in valve frame(1-1).

4. The quantitative water adjusting valve according to claim 3 is characterized in that the control mechanism(3) comprises a vertical rotating plate (3-1) and a rotating convex plate (3-2), an extending plate (3-3), a hand-rotating disk (3-4) and a long screw rod (3-5), a positioning insert block (3-6), a limit stop (3-7) and an elastic band (3-8); the left end of the lower end of the vertical rotating plate (3-1) is fixedly connected with a rotating convex plate (3-2); the rotating convex plate (3-2) is in clearance fit with the fixed column (1-3); the nut I on fixed column (1-3) is positioned at the upper end of the rotating convex plate (3-2); the vertical rotating plate (3-1) is slidably connected with a positioning insert block (3-6); the left end of the positioning insert block (3-6) is fixedly connected with a limit stop (3-7); the limit stop (3-7) is positioned at the left end of the vertical rotating plate (3-1), the two ends of the elastic band (3-8) are fixedly connected to the front end face and the rear end face of the vertical rotating plate (3-1) respectively, elastic band (3-8) is pressed at the left end of positioning insert block (3-6), the right end of the positioning insert block (3-6) is inserted into the annular groove (2-2); right lower end of positioning insert block (3-6) is an inclined surface; the front end of the lower end of the vertical rotating plate (3-1) is fixedly connected with an extending plate (3-3); the upper end of the extending plate (3-3) is fixedly connected with a long screw rod (3-5); the long screw rod (3-5) is connected with the hand-rotating disk (3-4) through threads.

5. The quantitative water adjusting valve according to claim 4 is characterized in that the sealing element (4) comprises a stepped rubber ring (4-1) and a ring (4-2); the stepped rubber ring(4-1) is of an upper wide lower narrow step shape, and the lower end of the stepped rubber ring(4-1) is sleeved with a ring(4-2), and the ring (4-2) is fixedly connected to the valve frame(1-1) through a screw (1-1), the stepped rubber ring (4-1) is in sliding fit with the column pressing body (2-1).

6. The quantitative water adjusting valve according to claim 5 is characterized in that the quantitative orifice plate (5) comprises an orifice plate body (5-1) and a lug plate (5-2); the orifice plate body (5-1) is in clearance fit with the quantitative orifice plate inserting groove (1-15), lug plates (5-2) are arranged at the left end and the right end of the orifice plates (5-1) , the two orifice plates (5-1) and the lug plate (5-2) are respectively inserted into the two lug plate grooves(1-17); the two threaded columns (1-16) is inserted into the lug plate (5-2) in a clearance fit manner; the two threaded columns (1-16) is connected with a nut III through threads; the orifice plate body (5-1) is pressed on the circular shaped sealing gasket (1-18); the two nuts III are pressed on the upper ends of the orifice plate bodies (5-1).

7. The quantitative water adjusting valve according to claim 6 is characterized in that the two end covers (6) is fixedly connected to the front end and the rear end of the valve frame(1-1)respectively; the end cover (6) is connected to four corner plates (1-13) through screws.

8. The quantitative water adjusting valve according to claim 6 is characterized in that the orifice plate body (5-1) is provided with a plurality of orifices; a plurality of orifices in the plurality of orifice plate bodies (5-1) are provided with a plurality of sizes.
